(19) United States
(12) Patent Application Publication
(10) Pub. No.: US 2023/0090097 A1
(43) Pub. Date: Mar. 23, 2023

(54) METHOD FOR REFRESHING ASYMMETRIC MIXED SOLUTION FOR REDOX FLOW BATTERIES

(71) Applicant: UOP LLC, Des Plaines, IL (US)

(72) Inventors: William T. Kender, Chicago, IL (US); Zara Osman, Glenview, IL (US)

(21) Appl. No.: 17/822,462

(22) Filed: Aug. 26, 2022

Related U.S. Application Data
(60) Provisional application No. 63/261,443, filed on Sep. 21, 2021.

(51) Int. Cl. H01M 8/18; H01M 8/04276; H01M 8/04746

(52) U.S. Cl. CPC H01M 8/188; H01M 8/04276; H01M 8/04746; H01M 2300/0011

(57) ABSTRACT

A method of refreshing an asymmetric redox flow battery system is described. The redox flow battery system comprises: at least one rechargeable cell comprising a positive electrolyte, a negative electrolyte, and a separator positioned between the positive electrolyte and the negative electrolyte, the positive electrolyte in contact with a positive electrode, and the negative electrolyte in contact with a negative electrode; the positive electrolyte comprising water and a metal precursor and having a volume; the negative electrolyte comprising water and the metal precursor and having a volume; the negative electrolyte having a concentration of the metal precursor greater than a concentration of the metal precursor in the positive electrolyte. The flow of mixed electrolyte past the negative electrode is prevented, and the negative electrolyte and positive electrolyte are mixed together. The mixed solution is reapportioned to the negative and positive sides based on the initial negative and positive electrolyte volumes. Flow of the refreshed negative electrolyte past the negative electrode is then resumed.

### RELATED APPLICATIONS

This application claims priority to U.S. Provisional Patent Application Ser. No. 63/261,443, filed on Sep. 21, 2021, the entirety of which is incorporated herein by reference.

### BACKGROUND

Redox flow batteries (RFBs) are composed of two external storage tanks filled with active materials comprising metal ions that may be in different valance states, two circulation pumps, and a flow cell with a separation membrane. The separation membrane is located between the negative electrode and the positive electrode and is used to separate the anolyte and the catholyte, as well as to utilize the current circuit by allowing the transfer of balancing ions. The anolyte, catholyte, negative electrode, and positive electrode may also be referred to as plating electrolyte or negative electrolyte, redox electrolyte or positive electrolyte, plating electrode or negative electrode, and redox electrode or positive electrode respectively. Among all the redox flow batteries developed to date, all vanadium redox flow batteries (VRFB) have been the most extensively studied. VRFB uses the same vanadium element in both half cells which prevents crossover contamination of electrolytes from one half cell to the other half cell. VRFB, however, is inherently expensive due to the use of high-cost vanadium and an expensive membrane. All-iron redox flow batteries (IFB) are particularly attractive for grid scale storage applications due to the use of low cost and availability of iron, salt, and water as the electrolyte as well as the non-toxic nature of the system. IFBs have iron in different valence states as both the positive and negative electrolytes for the positive and negative electrodes, respectively. The iron-based positive and negative electrolyte solutions stored in the external storage tanks flow through the stacks of the batteries. The positive electrode side half-cell reaction involves Fe²⁺ losing electrons to form Fe³⁺ during charge and Fe³⁺ gaining electrons to form Fe²⁺ during discharge; the reaction is given by Equation 1. The negative electrode side half-cell reaction involves the deposition and dissolution of iron in the form of a solid plate; the reaction is given by Equation 2. The overall reaction is shown in Equation 3.

Redox electrode: 2Fe²⁺↔Fe³⁺+2e⁻ +0.77V (1)

Plating electrode: Fe²⁺+2e⁻↔Fe⁰ −0.44V (2)

Total: 3Fe²⁺↔Fe⁰+2Fe³⁺ 1.21V (3)

During the normal operation of an RFB, small inefficiencies can create large problems over the lifetime of the battery. These problems can stem from a number of sources such as: cross-over of active species across the membrane, parasitic side reactions, or incomplete discharging of the battery. Even small inefficiencies can eventually result in a poorly performing battery in a product designed to last more than 20,000 cycles. Therefore, a process is needed which can correct these inefficiencies.

One solution to these problems is a mixed solution refresh. This involves fully discharging the battery, completely mixing the anolyte and catholyte, and reapportioning the mixed solution to the initial volumes. This process can fix a number of issues, including a volume differential driven by osmotic pressure, redistribution of supporting electrolyte, and the modulation of pH on both sides. The full discharge is used in the case of a hybrid RFB in order to ensure that as much of the active material is in solution as possible.

However, because the anolyte and catholyte are mixed together, the resulting solution contains an average of the molarity of the components in the original anolyte and catholyte solutions. This is not a problem when the anolyte and catholyte solutions are the same.

However, in some cases, it is desirable to have different solution compositions for the anolyte and catholyte. One reason for such a formulation is to have a higher concentration of Fe²⁺ in the anolyte. This is advantageous because it helps to prevent osmotic pressure differences between the anolyte and catholyte. However, a mixed solution refresh directly minimizes these beneficial properties by equalizing the iron concentration across both electrolytes.

A second example would be when the catholyte has been treated with HCl to lower the pH. This can be beneficial to battery performance as the HCl will increase conductivity in the catholyte. However, if HCl is added to the anolyte, it will provide a reservoir for H₂ production under charging. Thus, it would increase the voltaic efficiency (VE) if added to the catholyte, but decrease the coulombic efficiency (CE) if added to the anolyte. In cases such as this, a mixed solution refresh is not desirable, as the pH of the anolyte will decrease to levels which are too low for high efficiency iron plating.

Thus, if the design criteria calls for an asymmetric solution composition, the mixed solution refresh cannot be used.

Therefore, there is a need for a mixed solution refresh process for an RFB with asymmetric solution compositions.

### DESCRIPTION OF THE INVENTION

Microporous membranes made from polyethylene or polypropylene are commercially available, e.g., Daramic® and Celgard® membranes. They have high conductivity to the supporting electrolyte, which increases voltaic efficiency, but they also have high conductivity to the active species and water, which decreases coulombic and voltaic efficiencies respectively. This represents a problem to the long-term performance of batteries using these membranes.

When the osmotic pressure differential is high, there are two main mechanisms through which the potential energy is released by the cell: (1) water movement into the positive electrolyte and (2) Fe³⁺ movement, for example, into the negative electrolyte. The first mechanism results in the dilution of the active species in the positive electrolyte, and proportionally lowers the VE. The second mechanism directly reduces CE via a self-discharge method. By removing this driving force, the overall cell performance is greatly improved.

The volume movement across the membrane is reduced by utilizing differential metal concentrations on positive electrode and negative electrode sides of the battery. For instance, in one embodiment, 0.75 M FeCl₂ was employed on the positive side, while 1.25 M FeCl₂ was employed on the negative side. For a battery which has a ratio of 6:5 negative electrolyte to positive electrolyte, at 100% state of charge (SoC) on the positive side the resulting concentrations would be about 0.75 FeCl₂ on the negative side and 0.75 M FeCl₃ on the positive. This helps reduce osmotic pressure differences across the two sides compared to an equimolar system.

The concentration difference has the added benefit of decreased hydrogen evolution. Since hydrogen evolution and iron plating are competing reactions near the electrode surface on the negative side of the battery, elevated levels of Fe²⁺, for example, favor the iron plating reaction over the reduction of H⁺, thereby helping to improve the coulombic efficiency.

While there are some drawbacks associated with hybrid RFBs, the asymmetric nature of the negative electrode and positive electrode provides a unique opportunity for the control of electrolyte formulations during refresh conditions.

As discussed above, the concentration differential provides a number of benefits. But without a method to maintain this differential over a series of refreshes, it would be difficult to implement without a much more expensive membrane. This invention allows for a novel solution composition which increases VE by reducing osmotic pressure differences, and it also increases CE by directly increasing the rate of Fe⁰ generation compared to H₂,

The asymmetric mixed solution refresh provides a method for obtaining the benefits of a mixed solution refresh, while maintaining a concentration difference of the active species between the negative electrolyte and the positive electrolyte. It can also be used to maintain pH imbalances in a similar fashion.

The method will be discussed with respect to an iron RFB, but those of skill in the art will recognize that it could be used with other types of RFBs.

The method is carried out by partially or fully charging a hybrid RFB. In the case of an all-iron RFB, this results in plating Fe⁰ on the negative electrode and simultaneously lowering the [Fe²⁺] concentration within the negative electrolyte.

The flow of mixed electrolyte past the negative electrode is prevented, and then the negative and positive electrolyte are mixed together. The prevention of flow of the mixed electrolyte past the negative electrode prevents contact of the negative electrode with the mixed solution. The prevention of flow past negative electrode can be accomplished in any suitable manner. For example, the negative electrode can be disconnected from the system, or the pump to the negative electrode side can simply be turned off. Other methods could also be used, as would be understood by those of skill in the art.

The mixed solution has the average of the concentrations of Fe²⁺ and Fe³⁺ of the negative electrolyte and positive electrolyte before the mixing weighted on a volume basis. The mixed solution is reapportioned to the negative and positive sides based on the initial negative and positive electrolyte volumes, or different volumes as is appropriate.

Flow of the negative electrolyte past the negative electrode is then resumed, and the Fe³⁺ comproportionates with the plated Fe⁰ to release Fe²⁺ into solution. This results in an increase in both the specific [Fe²⁺] concentration and the total iron concentration in the negative electrolyte after the mixed solution refresh. The positive electrolyte remains at the iron concentration of the mixed solution refresh.

Depending on how much the battery was charged, the system may need be further discharged.

Using this process, the negative electrolyte can be maintained at a higher Fe²⁺ concentration than the positive electrolyte, while still mixing the negative electrolyte and positive electrolyte. The mixing of the two solutions can correct for water transfer, which lowers active species concentrations, or it can correct for imbalances in supporting electrolyte concentration due to parasitic side reactions, which lowers conductivity. The method achieves these benefits while still maintaining an iron differential between the two electrolytes. Ultimately, this method provides the benefits of a mixed solution refresh while maintaining an asymmetric system.

Through a similar method, the pH of the positive electrolyte can be manipulated. This can be used either to maintain a [H⁺] differential or to enhance the refresh method. By charging quickly at a higher current density than normally, the pH of the negative electrolyte can be raised via the formation of H₂. This can be recombined with the Fe³⁺ in the mixed solution after the negative electrode has been isolated. The increased [H⁺] can be used to strip iron precipitates or rust off the tubing and cell. This method raises the [H⁺] of the positive electrolyte solution higher than would otherwise be possible, by artificially creating a surplus of Fe³⁺ and H₂.

The positive and negative electrolytes comprise water and a metal precursor. The metal in the metal precursor comprises iron, copper, zinc manganese, titanium, tin, silver, vanadium, or cerium.

The concentration of the metal precursor in the negative electrolyte is greater than the concentration of the metal precursor in the positive electrolyte. For example, when the metal precursor is FeCl₂, the concentration of the metal precursor in the negative electrolyte may be in the range of 1.0-4.5 M, or 1.0-3.0 M, and the concentration of the metal precursor in the positive electrolyte may be in the range of 0.5-4.0 M, or 1.0-2.5 M.

The positive and/or negative electrolyte may also contain at least one of an amino acid, an inorganic acid, an organic acid, a supporting electrolyte, and boric acid.

The amino acid may have a side chain length of 1 to 6 carbon atoms.

Suitable amino acids include, but are not limited to, proline, glycine, alanine, valine, leucine, isoleucine, serine, and threonine. The concentration of the amino acid is typically in the range of 0.01 to 3.0 M, or 0.1 to 1.0 M.

Suitable inorganic acids include, but are not limited to, HF, HCl, HBr, HI, H₂SO₄, H₃PO₄, H₃BO₃ or combinations thereof. The concentration of the inorganic acid is typically in the range of 0.01 to 2.5 M, or 0.05 to 1.0 M.

Suitable organic acids include, but are not limited to, ascorbic acid, formic acid, acetic acid, citric acid, malic acid, tartaric acid, propionic acid, and butanoic acid. The concentration of the supporting electrolyte is typically in the range of 0.01 to 0.3M or 0.05 to 0.1M.

The supporting electrolyte provides available and mobile ions to complete the charging circuit. These ions migrate through the separator in order to balance the charge developed from moving electrons through the external circuit from one electrode to the other. The supporting electrolyte contains one or more ions comprising Li⁺, Na⁺, K⁺, Rb⁺, Cs⁺, NH₄⁺, Ca²⁺, Ba²⁺, Mg²⁺, SO₄⁻, F⁻, Cl⁻, or combinations thereof. For example, the supporting electrolyte could be LiCl, NaCl, Na₂SO₄, KCl, NH₄Cl, and the like. The concentration of the supporting electrolyte is typically in the range of 1.0-5.0 M, or 2.0-4.0 M.

The separator may comprise an ionically conductive membrane, a solid ion exchange media (e.g., a ceramic such as NaSClON, or a porous diffusion medium (e.g., a porous ceramic or dense gel electrolyte). The ionically conductive membrane can be any ionically conductive membrane. Suitable ionically conductive membranes include, but are not limited to, ionically conductive thin film composite membranes, ionically conductive asymmetric composite membranes, size exclusion membranes, anion exchange membranes, or cation exchange membranes.

Ionically conductive thin film composite (TFC) membranes may comprise a microporous support membrane and a hydrophilic ionomeric polymer coating layer on the surface of the microporous support membrane, wherein the hydrophilic ionomeric polymer coating layer is ionically conductive. A TFC membrane is described in U.S. application Ser. No. 17/389,032, filed Jul. 29, 2021, entitled Ionically Conductive Thin Film Composite Membranes for Energy Storage Applications, which is incorporated herein by reference in its entirety.

Ionically conductive asymmetric composite membranes may comprise a microporous substrate membrane; and an asymmetric hydrophilic ionomeric polymer coating layer on a surface of the microporous substrate layer, the coating layer made of a hydrophilic ionomeric polymer, the coating layer comprising; a porous layer having a first surface and a second surface, the first surface of the porous layer on the surface of the microporous substrate layer; and a nonporous layer on the second surface of the porous layer; wherein the microporous substrate membrane is made from a polymer different from the hydrophilic ionomeric polymer. An ionically conductive asymmetric composite membrane is described in U.S. application Ser. No. 17/388,950, filed Jul. 29, 2021, entitled Ionically Conductive Asymmetric Composite Membranes for Electrochemical Energy System Applications, which is incorporated herein by reference in its entirety.

Size-exclusion membranes may comprise materials which prevent the movement of ions or molecules which are above a certain size. These membranes will allow ions below the pore size of the membrane while rejecting those which are larger.

This can be useful in cases in which the active species in a RFB is larger than the supporting electrolyte ions.

Anion-exchange membranes may comprise —NH₃⁺, —NRH₂⁺, —NR₂H⁺, —NR₃⁺, or —SR₂⁻ anion exchange functional groups.

One example of an anion exchange membrane is a sandwich-structured thin film composite anion exchange membranes which may may comprise a microporous substrate membrane; a first hydrophilic ionomeric polymer coating layer on a surface of the microporous substrate membrane; a cross-linked protonated polymeric polyamine anion exchange layer on a second surface of the first hydrophilic ionomeric polymer coating layer; and a second hydrophilic ionomeric polymer coating layer on a second surface of the cross-linked protonated polymeric polyamine anion exchange layer. A sandwich-structured thin film composite anion exchange membrane is described in U.S. application Ser. No. 17/388,956, filed Jul. 29, 2021, entitled Sandwich-Structured Thin Film Composite Anion Exchange Membrane for Redox Flow Battery Applications, which is incorporated herein by reference in its entirety.

Cation-exchange membranes may comprise —SO₃⁻, —COO⁻, —PO₃²⁻, —PO₃H⁻, or —C₆H₄O⁻ cation exchange functional groups. The cation-exchange membrane can comprise a perfluorinated ionomer selected from, but is not limited to, Nafion®, Flemion NEOSEPTA®-F, a partially fluorinated polymer, a non-fluorinated hydrocarbon polymer, a non-fluorinated polymer with aromatic backbone, an acid-base blend, or combinations thereof.

Bipolar membranes may comprise both cation-exchange and anion-exchange polymers.

The hydrophilic ionomeric polymer in the TFC membrane, the asymmetric composite membrane, and the sandwich-structured thin film composite anion exchange membrane comprises a hydrophilic ionomeric polymer or a cross-linked hydrophilic polymer comprising repeat units of both electrically neutral repeating units and a fraction of ionized functional groups such as —SO₃⁻, —COO⁻, —PO₃²⁻, —PO₃H⁻, —C₆H₄O⁻6, —O₄B⁻, —NH₃⁺, —NRH₂⁺, —NR₂H⁺, —NR₃⁺, or —SR₂⁻. The hydrophilic ionomeric polymer contains high water affinity polar or charged functional groups such as —SO₃⁻, —COO⁻ or —NH₃⁺ group. The cross-linked hydrophilic polymer comprises a hydrophilic polymer complexed with a complexing agent such as polyphosphoric acid, boric acid, a metal ion, or a mixture thereof. The hydrophilic ionomeric polymer not only has high stability in an aqueous electrolyte solution due to its insolubility in the aqueous electrolyte solution, but also has high affinity to water and charge-carrying ions such as H₃O⁺ or Cl⁻ due to the hydrophilicity and ionomeric property of the polymer and therefore high ionic conductivity and low membrane specific area resistance.

Suitable hydrophilic ionomeric polymers include, but are not limited to, a polyphosphoric acid-complexed polysaccharide polymer, a polyphosphoric acid and metal ion-complexed polysaccharide polymer, a metal ion-complexed polysaccharide polymer, a boric acid-complexed polysaccharide polymer, an alginate polymer such as sodium alginate, potassium alginate, calcium alginate, ammonium alginate, an alginic acid polymer, a hyaluronic acid polymer, a boric acid-complexed polyvinyl alcohol polymer, polyphosphoric acid-complexed polyvinyl alcohol polymer, a polyphosphoric acid and metal ion-complexed polyvinyl alcohol polymer, a metal ion-complexed polyvinyl alcohol polymer, a metal ion-complexed poly(acrylic acid) polymer, a boric acid-complexed poly(acrylic acid) polymer, a metal ion-complexed poly(methacrylic acid), a boric acid-complexed poly(methacrylic acid), or combinations thereof.

Various types of polysaccharide polymers may be used, including, but not limited to, chitosan, sodium alginate, potassium alginate, calcium alginate, ammonium alginate, alginic acid, sodium hyaluronate, potassium hyaluronate, calcium hyaluronate, ammonium hyaluronate, hyaluronic acid, dextran, pullulan, carboxymethyl curdlan, sodium carboxymethyl curdlan, potassium carboxymethyl curdlan, calcium carboxymethyl curdlan, ammonium carboxymethyl curdlan, κ-carrageenan, λ-carrageenan, ι-carrageenan, carboxymethyl cellulose, sodium carboxymethyl cellulose, potassium carboxymethyl cellulose, calcium carboxymethyl cellulose, ammonium carboxymethyl cellulose, pectic acid, chitin, chondroitin, xanthan gum, or combinations thereof.

The microporous support membrane in the TFC membrane, the asymmetric composite membrane, and the sandwich-structured thin film composite anion exchange membrane should have good thermal stability (stable up to at least 100° C.), high aqueous and organic solution resistance (insoluble in aqueous and organic solutions) under low pH condition (e.g., pH less than 6), high resistance to oxidizing and reducing conditions (insoluble and no performance drop under oxidizing and reducing conditions), high mechanical strength (no dimensional change under the system operation conditions), as well as other factors dictated by the operating conditions for energy storage applications. The microporous support membrane must be compatible with the cell chemistry and meet the mechanical demands of cell stacking or winding assembly operations. The microporous support membrane has high ionic conductivity, but low selectivity of charge-carrying ions such as protons, hydrated protons, chloride ions, potassium ions, hydrated potassium ions, sodium ions, and hydrated sodium ions over the electrolytes such as ferric ions, hydrated ferric ions, ferrous ions, and hydrated ferrous ions.

The polymers suitable for the preparation of the microporous support membrane can be selected from, but not limited to, polyolefins such as polyethylene and polypropylene, polyamide such as Nylon 6, Nylon 6,6, polyacrylonitrile, polyethersulfone, sulfonated polyethersulfone, polysulfone, sulfonated polysulfone, poly(ether ketone), sulfonated poly(ether ketone), polyester, cellulose acetate, cellulose triacetate, polybenzimidazole, polyimide, polyvinylidene fluoride, polycarbonate, cellulose, or combinations thereof. These polymers provide a range of properties such as low cost, high stability in water and electrolytes under a wide range of pH, good mechanical stability, and ease of processability for membrane fabrication.

The microporous support membrane can have either a symmetric porous structure or an asymmetric porous structure. The asymmetric microporous support membrane can be formed by a phase inversion membrane fabrication approach followed by direct air drying, or by phase inversion followed by solvent exchange methods. The microporous support membrane also can be fabricated via a dry processing of thermoplastic polyolefins or a wet processing of thermoplastic olefins. The dry processing of thermoplastic polyolefins utilizes extrusion to bring the polymer above its melting point and form it into the desired shape. Subsequent annealing and stretching processes may also be done to increase the crystallinity and orientation and dimension of the micropores. The wet processing of polyolefin separators is done with the aid of a hydrocarbon liquid or low molecular weight oil mixed with the polymer resin or a mixture of the polymer resin and inorganic nanoparticles in the melt phase. The melt mixture is extruded through a die similar to the dry processed separators. The thickness of the microporous support membrane can be in a range of 10-1000 micrometers, or a range of 10-900 micrometers, or a range of 10-800 micrometers, or a range of 10-700 micrometers, or a range of 10-600 micrometers, or a range of 10-500 micrometers, or a range of 20-500 micrometers. The pore size of the microporous membrane can be in a range of 10 nanometers to 50 micrometers, or a range of 50 nanometers to 10 micrometers, or a range of 0.2 micrometers to 1 micrometer.

The operating temperature of the redox flow battery system is in a range of 10° C. to 90° C., or 20° C. to 65° C.

One aspect of the invention is a method of refreshing an asymmetric redox flow battery system. In one embodiment, the method comprises: providing a completely discharged or at least partially charged redox flow battery system comprising: at least one rechargeable cell comprising a positive electrolyte, a negative electrolyte, and a separator positioned between the positive electrolyte and the negative electrolyte, the positive electrolyte in contact with a positive electrode, and the negative electrolyte in contact with a negative electrode; the positive electrolyte comprising water and a metal precursor and having a volume; the negative electrolyte comprising water and the metal precursor and having a volume; the negative electrolyte having a concentration of the metal precursor greater than a concentration of the metal precursor in the positive electrolyte; and preventing the mixed electrolyte from flowing past the negative electrode; mixing the positive electrolyte and the negative electrolyte to form the mixed electrolyte having a concentration of metal precursor between the concentration of the metal precursor in the positive electrolyte and the concentration in the negative electrolyte; apportioning the mixed electrolyte based on the negative electrolyte volume and the positive electrolyte volume to form a refreshed negative electrolyte and a refreshed positive electrolyte; and resuming a flow of the refreshed negative electrolyte past the negative electrode.

In some embodiments, the method further comprises: lowering the pH of the mixed electrolyte using hydrogen gas in a separate hydrogen gas recombination system comprising the mixed electrolyte; and circulating the mixed electrolyte having the lower pH through the battery system while no mixed electrolyte is flowing past the negative electrode to remove precipitates, rust, or both, before apportioning the mixed electrolyte.

In some embodiments, the method further comprises: charging the battery system to plate metal on the negative electrode before preventing the mixed electrolyte from flowing past the negative electrode.

In some embodiments, the method further comprises: discharging the battery system after resuming the flow of the refreshed negative electrolyte past the negative electrode.

In some embodiments, providing the completely discharged or at least partially charged redox flow battery system comprises providing a fully charged redox flow battery system.

In some embodiments, the metal comprises iron, copper, or zinc.

In some embodiments, the metal comprises iron and wherein the metal precursor comprises FeCl₂, FeCl₃, FeSO₄, Fe₂(SO₄)₃, FeO, Fe, Fe₂O₃, or combinations thereof.

In some embodiments, the metal precursor in the negative electrolyte comprises FeCl₂ at the concentration of 1.0-4.5 M; and the metal precursor in the positive electrolyte comprises FeCl₂, at the concentration of 0.5-4.0 M.

In some embodiments, the separator comprises an ionically conductive membrane.

In some embodiments, the ionically conductive membrane comprises an ionically conductive thin film composite membrane, an ionically conductive asymmetric composite membrane, a size exclusion membrane, an anion exchange membrane, or a cation exchange membrane.

In some embodiments, the positive electrolyte, the negative electrolyte, or both further comprise at least one of: an amino acid, an inorganic acid, an organic acid, a supporting electrolyte, and boric acid.

In some embodiments, at least one of: the amino acid comprises an amino acid having a side chain length of 1 to 6 carbon atoms; the inorganic acid comprises HCl, H₂SO₄, or combinations thereof; and the supporting electrolyte comprises an ion comprising Li⁺, Na⁺, K⁺, Rb⁺, Cs⁺, NH₄⁺, Ca²⁺, Ba²⁺, Mg²⁺, SO₄²⁻, F⁻, Cl⁻, or combinations thereof.

In some embodiments, the negative electrolyte comprises FeCl₂ at the concentration of 1.0-5.0 M; and NaCl, KCl, NH₄Cl, or combinations thereof; optionally HCl; optionally boric acid; optionally glycine; and optionally FeCl₃; and the positive electrolyte comprises FeCl₂ at the concentration of 0.5-4.0 M; and NaCl, KCl, NH₄Cl, or combinations thereof; optionally glycine; optionally HCl; optionally boric acid; optionally an organic acid; and optionally FeCl₃.

Another aspect of the invention comprises a method of refreshing an asymmetric redox flow battery system. In one embodiment, the method comprises: charging the battery system to plate metal on a negative electrode, wherein the metal comprises iron, copper, or zinc; and wherein the metal redox flow battery system comprises: at least one rechargeable cell comprising a positive electrolyte, a negative electrolyte, and a separator positioned between the positive electrolyte and the negative electrolyte, the positive electrolyte in contact with a positive electrode, and the negative electrolyte in contact with the negative electrode; the positive electrolyte comprising water and a metal precursor and having a volume; and the negative electrolyte comprising water and the metal precursor and having a volume; the negative electrolyte having a concentration of the metal precursor greater than a concentration of the metal precursor in the positive electrolyte; preventing the mixed electrolyte from flowing past the negative electrode; mixing the positive electrolyte and the negative electrolyte to form the mixed electrolyte having a concentration of metal precursor between the concentration of the metal precursor in the positive electrolyte and the concentration in the negative electrolyte; apportioning the mixed electrolyte based on the negative electrolyte volume and the positive electrolyte volume to form a refreshed negative electrolyte and a refreshed positive electrolyte; and resuming a flow of the refreshed negative electrolyte past the negative electrode.

In some embodiments, the method further comprises: lowering the pH of the mixed electrolyte using hydrogen gas in a separate hydrogen gas recombination system comprising the mixed electrolyte; and circulating the mixed electrolyte having the lower pH through the battery system while no mixed electrolyte is flowing past the negative electrode to remove precipitates, rust, or both, before apportioning the mixed electrolyte.

In some embodiments, the method further comprises: discharging the battery system after resuming the flow of the refreshed negative electrolyte past the negative electrode.

In some embodiments, the metal precursor comprises FeCl₂, FeCl₃, FeSO₄, Fe₂(SO₄)₃, FeO, Fe, Fe₂O₃, or combinations thereof.

In some embodiments, the metal precursor in the negative electrolyte comprises FeCl₂ at the concentration of 1.0-4.5 M; and the metal precursor in the positive electrolyte comprises FeCl₂, at the concentration of 0.5-4.0 M.

In some embodiments, the positive electrolyte, the negative electrolyte, or both further comprise at least one of: an amino acid, an inorganic acid, a supporting electrolyte, and boric acid; and wherein at least one of: the amino acid comprises an amino acid having a side chain length of 1 to 6 carbon atoms; the inorganic acid comprises HCl, H₂SO₄, or combinations thereof; and the supporting electrolyte comprises an ion comprising Li⁺, Na⁺, K⁺, Rb⁺, Cs⁺, NH₄⁺, Ca²⁺, Ba²⁺, Mg²⁺, SO₄²⁻, F⁻, Cl⁻, or combinations thereof.

In some embodiments, the negative electrolyte comprises FeCl₂ at the concentration of 1.0-4.5 M; and NaCl, KCl, NH₄Cl, or combination thereof; optionally HCl; optionally boric acid; optionally glycine; optionally an organic acid; and optionally FeCl₃; and the positive electrolyte comprises FeCl₂ at the concentration of 0.5-4.0 M; and NaCl, KCl, NH₄Cl, or combinations thereof; optionally glycine; optionally HCl; optionally boric acid; optionally an organic acid; and optionally FeCl₃.

### EXAMPLES

### Example 1

An IFB was started with a concentration of 0.75 M FeCl₂ in the positive electrolyte and 1.25 M FeCl₂ in the negative electrolyte. The positive electrolyte volume was 100 mL, and the negative electrolyte volume was 120 mL. After charging several cycles, an asymmetric refresh was initiated. The cell was charged fully, and the negative electrode was disconnected from the mixed electrolyte. The negative and positive electrolytes were fully mixed and circulated through both the positive electrolyte and negative electrolyte tubing for greater than 12 hours without flowing past the negative electrode. At the end of the 12 hours the concentration of iron in the mixed solution was measured to be 0.8 M. The solution was reapportioned to 100 mL of the mixed electrolyte to become the refreshed positive electrolyte and 120 mL of the mixed electrolyte to become the refreshed negative electrolyte. The anode was reconnected to the refreshed negative electrolyte, and the refreshed negative electrolyte was flowed past the plated iron.

A full discharge was initiated by holding a potential of 0V until less than 10% of operation current was achieved. The concentration of the iron was measured in both the refreshed negative electrolyte and refreshed positive electrolyte to find a refreshed negative electrolyte [Fe²⁺] of 1.3 M and a refreshed positive electrolyte [Fe²⁺] of 0.7 M. Normal cycling was resumed thereafter. This shows that the differential in iron concentration can be maintained over the course of a refresh while still achieving the aims of mixing the solutions together. All supporting electrolyte, water, and proton concentrations were averaged weighted on a volume basis, but the [Fe²⁺] of the refreshed negative electrolyte remained higher than that of the refreshed positive electrolyte.

### Example 2

In a separate example, an IFB was started with a concentration of 0.75 M FeCl₂ in the positive electrolyte, and 1.25 M FeCl₂ in the negative electrolyte. The positive electrolyte volume was 100 mL and the negative electrolyte volume was 120 mL. After charging several cycles, an asymmetric refresh was initiated. The cell was charged fully, and the negative electrode was disconnected from the mixed electrolyte. The negative electrolyte and positive electrolyte were fully mixed to create the mixed electrolyte and circulated through both the positive and negative electrolyte tubing for greater than 12 hours while bypassing the anode. The mixed electrolyte passed through a hydrogen recombination system which combines H₂ with Fe³⁺ to generate Fe²⁺ and H⁺. During this time, the mixed electrolyte decreased in pH and removed precipitate and rust from the tubing of the battery.

At the end of the 12 hours, the concentration of iron in the mixed solution was measured to be 0.7 M. Then, the solution was reapportioned to 100 mL of the mixed electrolyte to become the refreshed positive electrolyte and 120 mL of the mixed electrolyte to become the refreshed negative electrolyte. The anode was then reconnected to the refreshed negative electrolyte, and the refreshed negative electrolyte was flowed past the plated iron.

A full discharge was then initiated by holding a potential of 0V until less than 10% of operation current was achieved. The concentration of the iron was measured in both the refreshed negative electrolyte and refreshed positive electrolyte to find a refreshed negative electrolyte [Fe²⁺] of 1.3 M and a refreshed positive electrolyte [Fe²⁺] of 0.7M. Normal cycling was resumed thereafter. This shows that the differential in iron concentration can be maintained over the course of a refresh while still achieving the aims of mixing the solutions together. All supporting electrolyte, water, and proton concentrations were averaged weighted on a volume basis, but the [Fe²⁺] of the refreshed negative electrolyte remained higher than that of the refreshed positive electrolyte. Additionally, the mixed solution was acidified in order to remove precipitates and rust during the procedure without lasting pH effects on the refreshed negative electrolyte.

### Specific Embodiments

While the following is described in conjunction with specific embodiments, it will be understood that this description is intended to illustrate and not limit the scope of the preceding description and the appended claims.

A first embodiment of the invention is a method of refreshing an asymmetric redox flow battery system comprising providing a completely discharged or at least partially charged redox flow battery system comprising at least one rechargeable cell comprising a positive electrolyte, a negative electrolyte, and a separator positioned between the positive electrolyte and the negative electrolyte, the positive electrolyte in contact with a positive electrode, and the negative electrolyte in contact with a negative electrode; the positive electrolyte comprising water and a metal precursor and having a volume; the negative electrolyte comprising water and the metal precursor and having a volume; the negative electrolyte having a concentration of the metal precursor greater than a concentration of the metal precursor in the positive electrolyte; and preventing the mixed electrolyte from flowing past the negative electrode; mixing the positive electrolyte and the negative electrolyte to form the mixed electrolyte having a concentration of metal precursor between the concentration of the metal precursor in the positive electrolyte and the concentration in the negative electrolyte; apportioning the mixed electrolyte based on the negative electrolyte volume and the positive electrolyte volume to form a refreshed negative electrolyte and a refreshed positive electrolyte; and resuming a flow of the refreshed negative electrolyte past the negative electrode. An embodiment of the invention is one, any or all of prior embodiments in this paragraph up through the first embodiment in this paragraph further comprising lowering the pH of the mixed electrolyte using hydrogen gas in a separate hydrogen gas recombination system comprising the mixed electrolyte; and circulating the mixed electrolyte having the lower pH through the battery system while no mixed electrolyte is flowing past the negative electrode to remove precipitates, rust, or both, before apportioning the mixed electrolyte. An embodiment of the invention is one, any or all of prior embodiments in this paragraph up through the first embodiment in this paragraph further comprising charging the battery system to plate metal on the negative electrode before preventing the mixed electrolyte from flowing past the negative electrode. An embodiment of the invention is one, any or all of prior embodiments in this paragraph up through the first embodiment in this paragraph further comprising discharging the battery system after resuming the flow of the refreshed negative electrolyte past the negative electrode. An embodiment of the invention is one, any or all of prior embodiments in this paragraph up through the first embodiment in this paragraph wherein providing the completely discharged or at least partially charged redox flow battery system comprises providing a fully charged redox flow battery system. An embodiment of the invention is one, any or all of prior embodiments in this paragraph up through the first embodiment in this paragraph wherein the metal comprises iron, copper, or zinc. An embodiment of the invention is one, any or all of prior embodiments in this paragraph up through the first embodiment in this paragraph wherein the metal comprises iron and wherein the metal precursor comprises FeCl₂, FeCl₃, FeSO₄, Fe₂(SO₄)₃, FeO, Fe, Fe₂O₃, or combinations thereof. An embodiment of the invention is one, any or all of prior embodiments in this paragraph up through the first embodiment in this paragraph wherein the metal precursor in the negative electrolyte comprises FeCl₂ at the concentration of 1.0-4.5 M; and the metal precursor in the positive electrolyte comprises FeCl₂, at the concentration of 0.5-4.0 M. An embodiment of the invention is one, any or all of prior embodiments in this paragraph up through the first embodiment in this paragraph wherein the separator comprises an ionically conductive membrane. An embodiment of the invention is one, any or all of prior embodiments in this paragraph up through the first embodiment in this paragraph wherein the ionically conductive membrane comprises an ionically conductive thin film composite membrane, an ionically conductive asymmetric composite membrane, a size exclusion membrane, an anion exchange membrane, or a cation exchange membrane. An embodiment of the invention is one, any or all of prior embodiments in this paragraph up through the first embodiment in this paragraph wherein the positive electrolyte, the negative electrolyte, or both further comprise at least one of an amino acid, an inorganic acid, an organic acid, a supporting electrolyte, and boric acid. An embodiment of the invention is one, any or all of prior embodiments in this paragraph up through the first embodiment in this paragraph wherein at least one of the amino acid comprises an amino acid having a side chain length of 1 to 6 carbon atoms; the inorganic acid comprises HCl, H₂SO₄, or combinations thereof; and the supporting electrolyte comprises an ion comprising Li⁺, Na⁺, K⁺, Rb⁺, Cs⁺, NH₄⁺, Ca²⁺, Ba²⁺, Mg²⁺, SO₄²⁻, F⁻, Cl⁻, or combinations thereof. An embodiment of the invention is one, any or all of prior embodiments in this paragraph up through the first embodiment in this paragraph wherein the negative electrolyte comprises FeCl₂ at the concentration of 1.0-4.5 M; and NaCl, KCl, NH₄Cl, or combinations thereof; optionally HCl; optionally boric acid; optionally glycine; and optionally FeCl₃; and the positive electrolyte comprises FeCl₂ at the concentration of 0.5-4.0 M; and NaCl, KCl, NH₄Cl, or combinations thereof; optionally glycine; optionally HCl; optionally boric acid; optionally an organic acid; and optionally FeCl₃.

A second embodiment of the invention is a method of refreshing an asymmetric redox flow battery system comprising charging the battery system to plate metal on a negative electrode, wherein the metal comprises iron, copper, or zinc; and wherein the metal redox flow battery system comprises at least one rechargeable cell comprising a positive electrolyte, a negative electrolyte, and a separator positioned between the positive electrolyte and the negative electrolyte, the positive electrolyte in contact with a positive electrode, and the negative electrolyte in contact with the negative electrode; the positive electrolyte comprising water and a metal precursor and having a volume; and the negative electrolyte comprising water and the metal precursor and having a volume; the negative electrolyte having a concentration of the metal precursor greater than a concentration of the metal precursor in the positive electrolyte; preventing the mixed electrolyte from flowing past the negative electrode; mixing the positive electrolyte and the negative electrolyte to form a mixed electrolyte having a concentration of metal precursor between the concentration of the metal precursor in the positive electrolyte and the concentration in the negative electrolyte; apportioning the mixed electrolyte based on the negative electrolyte volume and the positive electrolyte volume to form a refreshed negative electrolyte and a refreshed positive electrolyte; and resuming a flow of the refreshed negative electrolyte past the negative electrode. An embodiment of the invention is one, any or all of prior embodiments in this paragraph up through the second embodiment in this paragraph further comprising lowering the pH of the mixed electrolyte using hydrogen gas in a separate hydrogen gas recombination system comprising the mixed electrolyte; and circulating the mixed electrolyte having the lower pH through the battery system while no mixed electrolyte is flowing past the negative electrode to remove precipitates, rust, or both, before apportioning the mixed electrolyte. An embodiment of the invention is one, any or all of prior embodiments in this paragraph up through the second embodiment in this paragraph further comprising discharging the battery system after resuming the flow of the refreshed negative electrolyte past the negative electrode. An embodiment of the invention is one, any or all of prior embodiments in this paragraph up through the second embodiment in this paragraph wherein the metal precursor comprises FeCl₂, FeCl₃, FeSO₄, Fe₂(SO₄)₃, FeO, Fe, Fe₂O₃, or combinations thereof; An embodiment of the invention is one, any or all of prior embodiments in this paragraph up through the second embodiment in this paragraph wherein the metal precursor in the negative electrolyte comprises FeCl₂ at the concentration of 1.0-4.5 M; and the metal precursor in the positive electrolyte comprises FeCl₂, at the concentration of 0.5-4.0 M. An embodiment of the invention is one, any or all of prior embodiments in this paragraph up through the second embodiment in this paragraph wherein the positive electrolyte, the negative electrolyte, or both further comprise at least one of an amino acid, an inorganic acid, a supporting electrolyte, and boric acid; and wherein at least one of the amino acid comprises an amino acid having a side chain length of 1 to 6 carbon atoms; the inorganic acid comprises HCl, H₂SO₄, or combinations thereof; and the supporting electrolyte comprises an ion comprising Li⁺, Na⁺, K⁺, Rb⁺, Cs⁺, NH₄⁺, Ca²⁺, Ba²⁺, Mg²⁺, SO₄²⁻, F⁻, Cl⁻, or combinations thereof. An embodiment of the invention is one, any or all of prior embodiments in this paragraph up through the second embodiment in this paragraph wherein the negative electrolyte comprises FeCl₂ at the concentration of 1.0-4.5 M; and NaCl, KCl, NH₄Cl, or combinations thereof; optionally HCl; optionally boric acid; optionally glycine; optionally an organic acid; and optionally FeCl₃; and the positive electrolyte comprises FeCl₂ at the concentration of 0.5-4.0 M; and NaCl, KCl, NH₄Cl, or combinations thereof; optionally glycine; optionally HCl; optionally boric acid; optionally an organic acid; and optionally FeCl₃.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A method of refreshing an asymmetric redox flow battery system comprising:
providing a completely discharged or at least partially charged redox flow battery system comprising:
at least one rechargeable cell comprising a positive electrolyte, a negative electrolyte, and a separator positioned between the positive electrolyte and the negative electrolyte, the positive electrolyte in contact with a positive electrode, and the negative electrolyte in contact with a negative electrode;
the positive electrolyte comprising water and a metal precursor and having a volume;
the negative electrolyte comprising water and the metal precursor and having a volume;
the negative electrolyte having a concentration of the metal precursor greater than a concentration of the metal precursor in the positive electrolyte; and
preventing a mixed electrolyte from flowing past the negative electrode;
mixing the positive electrolyte and the negative electrolyte to form the mixed electrolyte having a concentration of metal precursor between the concentration of the metal precursor in the positive electrolyte and the concentration in the negative electrolyte;
apportioning the mixed electrolyte based on the negative electrolyte volume and the positive electrolyte volume to form a refreshed negative electrolyte and a refreshed positive electrolyte; and
resuming a flow of the refreshed negative electrolyte past the negative electrode.

2. The method of claim 1 further comprising:
lowering the pH of the mixed electrolyte using hydrogen gas in a separate hydrogen gas recombination system comprising the mixed electrolyte; and
circulating the mixed electrolyte having the lower pH through the battery system while no mixed electrolyte is flowing past the negative electrode to remove precipitates, rust, or both, before apportioning the mixed electrolyte.

3. The method of claim 1 further comprising:
charging the battery system to plate metal on the negative electrode before preventing the mixed electrolyte from flowing past the negative electrode.

4. The method of claim 1 further comprising:
discharging the battery system after resuming the flow of the refreshed negative electrolyte past the negative electrode.

5. The method of claim 1 wherein providing the completely discharged or at least partially charged redox flow battery system comprises providing a fully charged redox flow battery system.

6. The method of claim 1 wherein the metal comprises iron, copper, or zinc.

7. The method of claim 1 wherein the metal comprises iron and wherein the metal precursor comprises FeCl₂, FeCl₃, FeSO₄, Fe₂(SO₄)₃, FeO, Fe, Fe₂O₃, or combinations thereof.

8. The method of claim 1 wherein:
the metal precursor in the negative electrolyte comprises FeCl₂ at the concentration of 1.0-4.5 M; and
the metal precursor in the positive electrolyte comprises FeCl₂, at the concentration of 0.5-4.0 M.

9. The method of claim 1 wherein the separator comprises an ionically conductive membrane.

10. The method of claim 9 wherein the ionically conductive membrane comprises an ionically conductive thin film composite membrane, an ionically conductive asymmetric composite membrane, a size exclusion membrane, an anion exchange membrane, or a cation exchange membrane.

11. The method of claim 1 wherein the positive electrolyte, the negative electrolyte, or both further comprise at least one of: an amino acid, an inorganic acid, an organic acid, a supporting electrolyte, and boric acid.

12. The method of claim 11 wherein at least one of:
the amino acid comprises an amino acid having a side chain length of 1 to 6 carbon atoms;
the inorganic acid comprises HCl, H₂SO₄, or combinations thereof; and
the supporting electrolyte comprises an ion comprising Li⁺, Na⁺, K⁺, Rb⁺, Cs⁺, NH₄⁺, Ca²⁺, Ba²⁺, Mg²⁺, SO₄²⁻, F⁻, Cl⁻, or combinations thereof.

13. The method of claim 1 wherein:
the negative electrolyte comprises FeCl₂ at the concentration of 1.0-4.5 M; and NaCl, KCl, NH₄Cl, or combinations thereof; optionally HCl; optionally boric acid; optionally glycine; and optionally FeCl₃; and
the positive electrolyte comprises FeCl₂ at the concentration of 0.5-4.0 M; and NaCl, KCl, NH₄Cl, or combinations thereof; optionally glycine; optionally HCl; optionally boric acid; optionally an organic acid; and optionally FeCl₃.

14. A method of refreshing an asymmetric redox flow battery system comprising:
charging the battery system to plate metal on a negative electrode, wherein the metal comprises iron, copper, or zinc; and wherein the metal redox flow battery system comprises:
at least one rechargeable cell comprising a positive electrolyte, a negative electrolyte, and a separator positioned between the positive electrolyte and the negative electrolyte, the positive electrolyte in contact with a positive electrode, and the negative electrolyte in contact with the negative electrode;
the positive electrolyte comprising water and a metal precursor and having a volume; and
the negative electrolyte comprising water and the metal precursor and having a volume;
the negative electrolyte having a concentration of the metal precursor greater than a concentration of the metal precursor in the positive electrolyte;
preventing a mixed electrolyte from flowing past the negative electrode;
mixing the positive electrolyte and the negative electrolyte to form the mixed electrolyte having a concentration of metal precursor between the concentration of the metal precursor in the positive electrolyte and the concentration in the negative electrolyte;
apportioning the mixed electrolyte based on the negative electrolyte volume and the positive electrolyte volume to form a refreshed negative electrolyte and a refreshed positive electrolyte; and
resuming a flow of the refreshed negative electrolyte past the negative electrode.

15. The method of claim 14 further comprising:
lowering the pH of the mixed electrolyte using hydrogen gas in a separate hydrogen gas recombination system comprising the mixed electrolyte; and
circulating the mixed electrolyte having the lower pH through the battery system while no mixed electrolyte is flowing past the negative electrode to remove precipitates, rust, or both, before apportioning the mixed electrolyte.

16. The method of claim 14 further comprising:
discharging the battery system after resuming the flow of the refreshed negative electrolyte past the negative electrode.

17. The method of claim 14 wherein the metal precursor comprises FeCl₂, FeCl₃, FeSO₄, Fe₂(SO₄)₃, FeO, Fe, Fe₂O₃, or combinations thereof.

18. The method of claim 14 wherein:
the metal precursor in the negative electrolyte comprises FeCl₂ at the concentration of 1.0-4.5 M; and
the metal precursor in the positive electrolyte comprises FeCl₂, at the concentration of 0.5-4.0 M.

19. The method of claim 14 wherein the positive electrolyte, the negative electrolyte, or both further comprise at least one of: an amino acid, an inorganic acid, a supporting electrolyte, and boric acid; and
wherein at least one of:
the amino acid comprises an amino acid having a side chain length of 1 to 6 carbon atoms;
the inorganic acid comprises HCl, H₂SO₄, or combinations thereof; and
the supporting electrolyte comprises an ion comprising Li⁺, Na⁺, K⁺, Rb⁺, Cs⁺, NH₄⁺, Ca²⁺, Ba²⁺, Mg²⁺, SO₄²⁻, F⁻, Cl⁻, or combinations thereof.

20. The method of claim 14 wherein:
the negative electrolyte comprises FeCl₂ at the concentration of 1.0-4.5 M; and NaCl, KCl, NH₄Cl, or combinations thereof; optionally HCl; optionally boric acid; optionally glycine; optionally an organic acid; and optionally FeCl₃; and
the positive electrolyte comprises FeCl₂ at the concentration of 0.5-4.0 M; and NaCl, KCl, NH₄Cl, or combinations thereof; optionally glycine; optionally HCl; optionally boric acid; optionally an organic acid; and optionally FeCl₃.
